(19) United States
(12) Patent Application Publication
(10) Pub. No.: US 2006/0126909 A1
(43) Pub. Date: Jun. 15, 2006

(54) Monitoring and control of mammographic computer-aided detection processing

(76) Inventors: Julian Marshall, Los Altos, CA (US); Mark B. Ivey, Sunnyvale, CA (US); Brian T. Matuska, Stockton, CA (US); John R. Johns II, Fremont, CA (US)

Correspondence Address: Law Office of Brian J. Daiuto, 886 ILIMA COURT, Palo Alto, CA, 94306-2615, US

(21) Appl. No.: 10/998,121

(22) Filed: Nov. 26, 2004

(51) Int. Cl. G06K 9/00

(52) U.S. Cl. 382/128

(57) ABSTRACT

A system, method, and related computer program products for processing mammographic data are described. A digitizer receives a plurality of film cases arranged in a film case sequence, each film case comprising at least one mammographic film, the digitizer scanning each film case for generating a digitized version thereof. A processor processes the digitized versions according to at least one computer-aided detection (CAD) algorithm for detecting anatomical abnormalities therein. A display coupled to the processor displays a graphical status indicator comprising a plurality of film case icons, each film case icon corresponding to one of the film cases, wherein the film case icons are spatially ordered according to the film case sequence, and wherein each film case icon is configured to graphically communicate a current state of the scanning/processing for its corresponding film case.

### FIELD

This patent specification relates to computer-aided detection (CAD) workflow processes in medical imaging environments. More particularly, this patent specification relates to monitoring and controlling the CAD processing of film-based and/or digitally-acquired mammogram images.

### BACKGROUND

Computer-aided detection (CAD) generally refers to the use of computers to analyze medical images to detect anatomical abnormalities therein. Sometimes used interchangeably with the term computer-aided detection are the terms computer-aided diagnosis, computer-assisted diagnosis, or computer-assisted detection. CAD results are mainly used by radiologists and other medical professionals as “secondary reads” or secondary diagnoses tools. When analyzing a medical image, the radiologist usually makes his or her own analytical determinations before looking at the CAD results, which either verify those determinations or trigger further inspection of the image. Some CAD implementations have used CAD results in a “concurrent reading” context in which the radiologists look at the CAD results at the same time that they look at the images.

In the field of mammography, thousands of mammography CAD systems are now installed worldwide, and are used to assist radiologists in the interpretation of millions of mammograms per year. Mammography CAD systems are described, for example, in U.S. Pat. No. 5,729,620, U.S. Pat. No. 5,815,591, and U.S. Pat. No. 5,917,929, each of which is incorporated by reference herein. Mammography CAD algorithms analyze digital or digitized images of standard mammographic views (e.g. CC, MLO) for characteristics commonly associated with breast cancer, such as calcifications, masses, and architectural distortions. The outputs of CAD systems, generally referred to herein as CAD results, are sets of information sufficient to communicate the locations of anatomical abnormalities, or lesions, in a medical image, and can also include other information such as the type of lesion, degree of suspiciousness, and the like. CAD results are most often communicated in the form of reduced-resolution versions of the different mammographic views containing annotations that identify the location and type of potential abnormality. The radiologist analyzes the original mammogram, either in film format on a light box or in digital form on a softcopy workstation, and then reviews the CAD results, usually on a display monitor or a paper printout.

Workflow processes associated with mammography, including CAD-related workflow processes, implicate substantial cost issues in practical clinical environments. The promise of “all-digital” mammography environments, in which digitally captured mammograms could be automatically shepherded, with little or no human intervention, through CAD systems and related HIS/RIS (Hospital Information System/Radiology Information System) equipment directly to the radiologists' viewing workstations, have not necessarily materialized as might have historically been anticipated. According to one estimate, approximately 94 percent of all mammography systems worldwide are still film-based units, and an equivalent percentage of all mammograms taken yearly are film-based mammograms rather than digital mammograms. Because film-based mammograms require digitization prior to performance of CAD algorithms, a substantial number of workflow-related issues can arise.

Several workflow issues relating to film-based mammography CAD relate to the slowness of the digitization or scanning process. For a CAD algorithm to be effective, it is usually desirable for a typical 18×24 cm or 24×30 cm film mammogram to be digitized at about 50 microns of spatial resolution and about 12 bits of dynamic range. Even using today's scanning technologies, it can take a commercial film scanner 15-60 seconds to digitize one film at these resolutions, and therefore it can take 1-4 minutes to digitize a typical film case having 4 views. A stack of 20 cases can therefore take an hour to run through the digitizer. At least theoretically, the technologist who placed the film stack in the scanner should be able to perform other duties while the digitization is taking place. However, although progress has been made toward automation of the film scanning process, as reflected in WO 02/43457 A2, which is incorporated by reference herein, and which describes automatic film orientation and identification based on lead view marker and breast outline segmentation, there are still several practical problems that arise which necessitate substantial technologist oversight of the scanning process during this long scanning interval. For example, films can stick together and cause misfeeds. One or more views of the breast might not register correctly with the automated identification system. There may be HIS/RIS database errors causing missed associations between patient IDs and film case IDs. Image storage devices may be full or temporarily offline. Each of these can cause an error or alert condition, and each can contribute to expensive “babysitting” time spent by the technologist.

Accordingly, in a mammography CAD environment, it would be desirable to provide a system for film digitization and/or CAD processing that is easier for a technologist to monitor and control, which can lead to cost savings and increased productivity.

It would be further desirable to provide such a digitization and/or processing system in a manner that flexibly accommodates digital mammogram cases as well as film mammogram cases using the same processor, thereby facilitating evolution from film environments to digital environments.

It would be further desirable to provide combined film-based CAD capability and digital CAD capability in a manner that seamlessly combines monitoring and control of both processes in a single user interface.

### SUMMARY

A system, method, and related computer program products are provided for the processing of mammographic data, comprising a digitizer receiving a plurality of film cases arranged in a film case sequence, each film case comprising at least one mammographic film, the digitizer scanning each film case for generating a digitized version thereof. A processor processes the digitized versions according to at least one computer-aided detection (CAD) algorithm for detecting anatomical abnormalities therein. A display coupled to the processor displays a graphical status indicator comprising a plurality of film case icons, each film case icon corresponding to one of the film cases, wherein the film case icons are spatially ordered according to the film case sequence, and wherein each film case icon is configured to graphically communicate a current state of the scanning and processing for its corresponding film case.

Preferably, each film case icon occupies an area of said display sufficient to graphically communicate the current state at a viewing distance of at least five (5) meters. Thus, for example, the graphical status indicator allows the technologist to effectively monitor the scanning process with occasional glances from across the clinic floor, or occasional glances through a doorway, without needing to be physically adjacent to the display device. In another preferred embodiment, the display comprises a touchscreen and the film case icons have softbutton functionality allowing fast, one-touch access to the details of any particular film case by touching its film case icon. Each of the film case icons graphically communicates the current state of its corresponding film case by varying at least one of a color, size, visual texture, or shape configuration according to that current state.

According to another preferred embodiment, seamless orchestration of (i) film mammogram scanning, CAD processing, and dispensing, and (ii) digital mammogram receiving, CAD processing, and dispensing, is facilitated. A plurality of film cases is scanned to generate digitized versions thereof, each film case comprising at least one mammographic film. A plurality of digital cases is received, each digital case comprising at least one digital mammogram derived from a non-film-based mammography acquisition device. The digitized versions and the digital mammograms are processed according to at least one CAD algorithm for detecting anatomical abnormalities therein. During these processes, a graphical status indicator is displayed comprising a plurality of film case icons individually corresponding to the film cases and a plurality of digital case icons individually corresponding to the digital cases. The film case icons and the digital case icons are in a common spatial arrangement according to a common time sequence in which the film cases were scanned and the digital cases received. Each of the film case icons and the digital case icons is configured to graphically communicate a current state of the scanning and/or processing taking place for its corresponding film case or digital case, respectively. Each of the film and digital case icons graphically communicates the current state of its corresponding film or digital case by varying at least one of a color, size, visual texture, or shape configuration according to that current state.

According to another preferred embodiment, a method for processing mammographic data is provided, comprising receiving a plurality of cases, each case comprising at least one of a digital and digitized mammogram, processing the cases according to at least one computer-aided detection (CAD) algorithm for detecting anatomical abnormalities therein, and displaying a graphical status indicator comprising a plurality of case icons. Each case icon corresponds to either (i) one case, or (ii) a group of case received adjacently in time and having a common current processing state associated with the CAD processing. The case icons are spatially arranged according to time received. Each case icon is configured to graphically communicate the current state for its corresponding case or group of cases by varying at least one of a color, size, visual texture, or shape configuration according to the current state.

### BRIEF DESCRIPTION OF THE DRAWINGS

FIG. 1 illustrates a CAD station in a combination film-based and digital mammography environment according to a preferred embodiment;

FIG. 2 illustrates a display screen corresponding to the CAD station of FIG. 1 according to a preferred embodiment;

FIG. 3 illustrates a simplified perspective view of the CAD station of FIG. 1 in a typical clinical environment;

FIG. 4 illustrates steps for pushing case icons onto, and pulling case icons off, a graphical status indicator stack according to a preferred embodiment;

FIG. 5 illustrates steps for updating case icon appearances according to a preferred embodiment;

FIG. 6 illustrates a graphical status indicator according to a preferred embodiment;

FIG. 7 illustrates a hypothetical extended view of a graphical status indicator according to a preferred embodiment; and

FIG. 8 illustrates a display screen corresponding to the CAD station of FIG. 1 according to a preferred embodiment.

### DETAILED DESCRIPTION

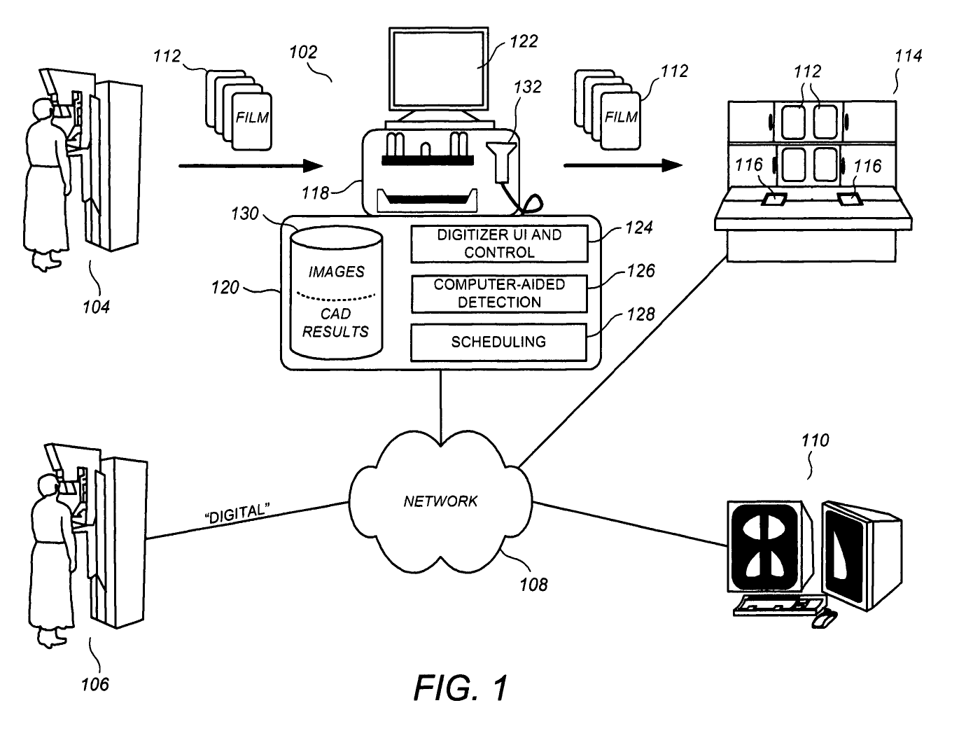

FIG. 1 illustrates a CAD station 102 in a combination film-based and digital mammography environment according to a preferred embodiment, including a film-screen mammogram acquisition device 104 and a digital mammogram acquisition device 106. The digital mammogram acquisition device 106 is coupled to a network 108, usually a HIS/RIS (Hospital Information System/Radiology Information System) network. As used herein, digital case refers to a group of mammogram images corresponding to a patient and acquired from a digital mammogram acquisition device. Although a symptomatic persons undergoing the mammographic imaging process are termed “clients” rather than “patients” in many clinics to denote that they are not symptomatic, the single term “patient” is used herein for simplicity and clarity of description. The group of digitally-acquired mammogram images forming the digital case is usually obtained during the same patient visit. The network 108 transfers the digital cases to the CAD station 102 for CAD processing. Upon successful completion of the CAD processing, CAD results are then transferred over the network 108 to a softcopy workstation 110 for review by a radiologist or other medical professional in conjunction with the digitally-acquired mammogram images. There may be more than one digital mammogram acquisition device, each having a different hardware address with respect to the network 108.

As used herein, film case refers to a group of mammogram images corresponding to a patient, the mammogram images being acquired using a film-based mammogram acquisition device. The group of mammogram images forming the film case is usually obtained during the same patient visit. Illustrated in FIG. 1 are film cases 112 that are physically carried over to the CAD station 102 for scanning and CAD processing, and subsequently physically carried over to a film review station 114. Upon successful completion of the CAD processing, CAD results are transferred over the network 108 to the film review station 114. In one common scenario, the film review station 114 comprises a motorized viewer upon which the film cases 112 are loaded and synchronized with digital displays 116 that show reduced-resolution versions of the mammogram images annotated with CAD markers and other information derived from the CAD results.

Notably, the environment of FIG. 1 around the CAD station 102 is presented by way of example only and is not intended to limit the scope of the preferred embodiments to this particular scenario. By way of example, many different setups can be used for reviewing film cases and their associated CAD results, such as simple light boxes in conjunction with paper printouts of the CAD results. By way of further example, different combinations of the devices of FIG. 1 can be placed adjacently to each other or integrated into the same hardware boxes without departing from the scope of the preferred embodiments. By way of still further example, the network 108 can be a wide-area network with the different nodes being distributed throughout a city, a country, or the world. Alternatively, and by way of still further example, some or all of the transfer of digital information can be achieved by physical transfer of disks, memory sticks, or other digital media devices without departing from the scope of the preferred embodiments. It is to be appreciated that although FIG. 1 illustrates a combined film/digital environment, many of the preferred embodiments herein are applicable in film-only environments and/or in digital-only environments as well.

CAD station 102 comprises a film scanner 118, which can also be termed a film digitizer, for scanning and digitizing the film cases 112. The film scanner 118 can comprise a laser scanner such as the DICOM 2908 Laser Film Digitizer from Array, Inc. Alternatively, the film scanner 118 can comprise a CCD scanner or other scanner having similar film scanning capabilities as the above laser and/or CCD scanners. The CAD station 102 further comprises a processor 120 and a display 122, which is preferably a touchscreen display but which can alternatively be implemented on a non-touchscreen monitor using an associated mouse or other pointing/selection device. The processor 120 comprises a digitizer user interface and control unit 124, a computer-aided detection (CAD) unit 126, a scheduling unit 128, and a data storage unit 130.

In one preferred embodiment, the functionalities of the digitizer user interface unit 124, the computer-aided detection (CAD) unit 126, the scheduling unit 128, and the data storage unit 130 are combined into a single, off-the-shelf personal computer (PC) box having an Intel Pentium IV processor with hyper-threading capability and running the Linux operating system. The user-interface, scanning control, data transfer, and scheduling fluctionalities described herein can be programmed in C++ using the GTK toolkit and G++ compiler.

The data storage unit 130 stores received digital cases and scanned film cases, along with their associated CAD results, according to a circular buffer arrangement based on times received and scanned. Cases are queued for CAD processing in the order of priority and, within a particular priority, in the order of time received or scanned. In one preferred embodiment, all film cases are assigned a medium priority, while digital cases are assigned a high, medium, or low priority according to which digital mammography acquisition device they originated from, this priority level being assigned at the installation time of the CAD station 102 or during a maintenance session thereof. In another preferred embodiment, the CAD station 102 may expose more than one port, or expose more than one DICOM Application Entity (AE), to the HIS/RIS network, with each port or AE corresponding to a different priority level. In this case, each of the digital mammogram acquisition workstations can establish associations with the desired port or AE according to a desired CAD processing priority determined at the digital mammogram acquisition workstation, and priority levels can thereby be assigned on a per-case basis. Any of a variety of other prioritization schemes are within the scope of the preferred embodiments.

CAD station 102 further comprises a handheld barcode scanner 132 that facilitates convenient access to any particular film case based on the barcode of its case separator sheet. In a typical film-based CAD workflow, a separator sheet having a CAD case ID is placed on top of the first sheet of each film case in a stack of film cases being fed into the film scanner 118, as described in WO 02/43457 A2. The CAD case ID, which is temporarily unique but generally re-usable according to the number of separator sheets in use at the clinic, is associated with a patient ID, case ID, accession number, etc., of a particular patient for a particular mammogram case, usually just before the acquisition of the film mammogram, in accordance with whichever HIS/RIS database system is used at that clinic. As described in WO 02/43457 A2, during scanning of the film stack, the film scanner reads the barcode of each separator sheet to differentiate the respective film cases, as well as to allow association between that CAD case ID and the rest of the information for that film case. Previously, if a problem arose with a particular case that might not be discovered, for example, until the time of loading of the film sheets 112 onto the film review station 114, then it could be difficult for the technologist to retrieve information on what went wrong at the CAD station. According to a preferred embodiment herein, the technologist can now simply scan the barcode on the separator sheet using the handheld barcode scanner 132, and the information is instantly displayed on the display 122.

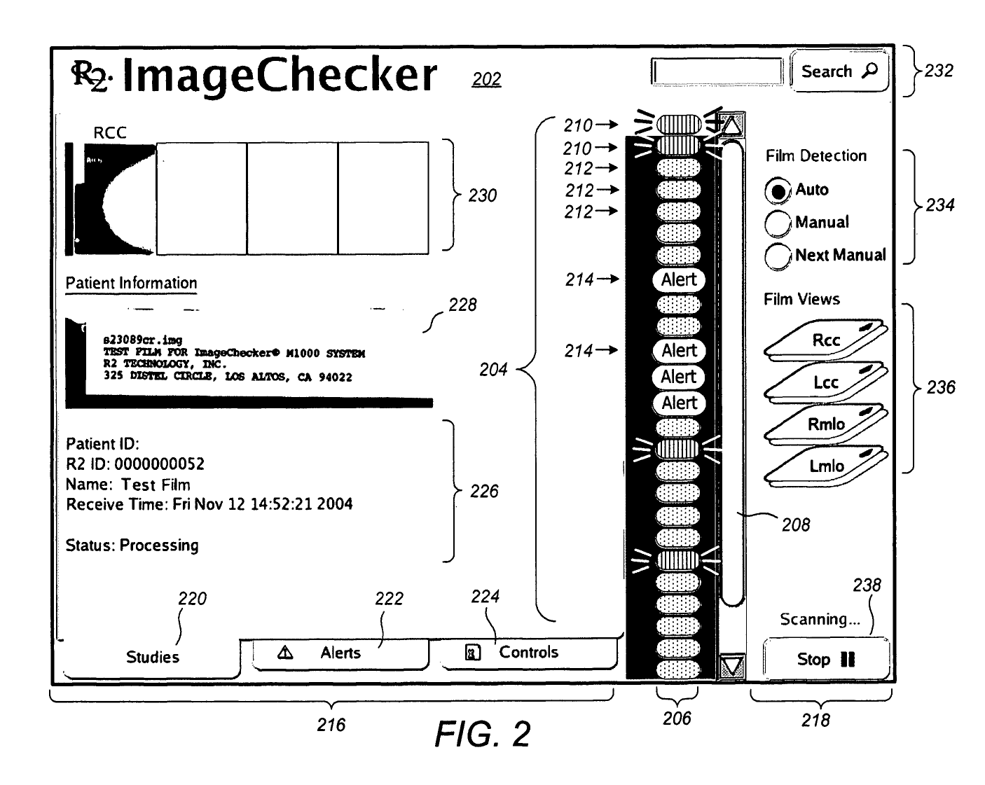

FIG. 2 illustrates a display screen 202 corresponding to the CAD station of FIG. 1 according to a preferred embodiment. Display screen 202 comprises a graphical status indicator 204 configured to be meaningfully viewable at a substantial distance, such as 5 meters, such that a technologist can more easily keep an eye on the scanning and CAD processing while also getting other things done in the clinical environment. Graphical status indicator 204 comprises a plurality of case icons 206, each case icon corresponding to one of the cases (film or digital) received by the CAD station 102. The case icons are arranged according to a time sequence in which the corresponding case was received, that is, the time the digital cases were delivered and the times the film cases were scanned, with the newest case on top and oldest case on the bottom. Each case icon 206 is configured to graphically communicate a current state of the CAD processing for that case, which for film cases includes scanning as well.

In one preferred embodiment, the graphical communication is achieved according to a common status designation scheme for both digital and film case icons, i.e., the digital case icons look like the film case icons. Alternatively, the digital case icons can have different appearances than the film case icons, or can be substantially similar except perhaps for a “D” in the lower corner to designate digital. The graphical status indicator is scrollable, as indicated by the scroll bar 208, with case icons 206 being generally available for all of the cases that are still on the data storage unit 130. It has been found that icons of the general shape and orientation of FIG. 2 are sufficiently viewable at 5 meters if they have an area of at least about 1 square centimeter on the display. The case icons should be large enough to be pressed by a standard human finger.

Generally speaking, the case icons graphically communicate the current state of the processing of their associated cases by achieving different looks for each different current state. Preferably, the different looks for the different processing states are chosen such that they are distinguishable from each other at a distance. The case icons can vary from each other in at least one color, size, visual texture (e.g., patterns such as cross-hatching, stippling, etc., or temporal variations such as blinking), and shape such that they are distinguishable from each other at a distance. By way of example in FIG. 2, case icons 210 are blinking, gray-colored icons and correspond to film cases that are being scanned or CAD-processed, as well as digital cases that are being received or CAD-processed. Case icons 212 are green-colored icons and correspond to cases (film or digital) that have been successfully CAD-processed and that have had the associated CAD results successfully dispensed to the appropriate destination device (e.g., the stations 110 or 114, or a printer). Case icons 214 are larger, bright-colored icons (such as yellow), optionally with the word “Alert” written on them, corresponding to cases in which something has not gone correctly and where attention in some form is needed or suggested.

Display 202 further comprises a detail display area 216 within which the user can view any of the details associated with a studies tab 220, an alerts tab 224, and a controls tab 226. The alerts tab 224 invokes an alert history listing, and the tab itself shows a triangular alert icon if there are any alerts present since last being cleared. The controls tab allows access to a variety of maintenance and configuration screens, and the tab itself shows a small wrench icon if there is something requiring maintenance-related attention (e.g., it is time to perform periodic calibration or other maintenance activity, or a diagnostic error occurred on startup, etc.)

The studies tab 220 causes the details of the currently selected case to be displayed, including text details 226, a patient flash area 228 containing the flash of a scanned film, and a thumbnail area 230 showing thumbnails of mammographic views that have been successfully scanned and/or processed thus far. The display 202 further comprises a search area 232 allowing searching by any of a variety of criteria (e.g., patient ID, patient name, CAD case ID, accession number, etc.). A scanning type selection area 234 allows the user to select between (a) an “Auto” mode in which automatic film orientation and identification based on lead view marker and breast outline segmentation is performed (see WO 02/43457 A2, supra), (b) a “Manual” mode in which the films for each case need to be placed in a predetermined orientation indicated by film view icons 236 and identified as being present by manually pressing on those film view icons 236, and (c) a “Next Manual” mode in which just the next film scanned will be in Manual mode. Finally, a start/stop button 238 is used to start and stop the overall process, which reads “Stop” when scanning/processing is under way and “Start” when no scanning/processing is occurring.

According to one preferred embodiment, a control is provided that causes the display of only film case icons, or only digital case icons, even if both types of cases are present on the data storage unit 130. Thus, for example, at a first time the technologist could focus on the film case icons only, at a second time he or she could focus on the digital case icons, and at a third time he or she could view the combined stack of film and digital case icons. Pressing on any one of the icons causes the current information for that case to be displayed in the display area 216. If no particular case icon has been pressed, the current information for the most recently received case is displayed, corresponding to the most recent case icon on the stack, as indicated in the particular example of FIG. 2. Preferably, the graphical status indicator 204 is omnipresent on the display so that even if a first technologist is interacting with a particular case, for example, a second technologist can see the graphical status indicator 204.

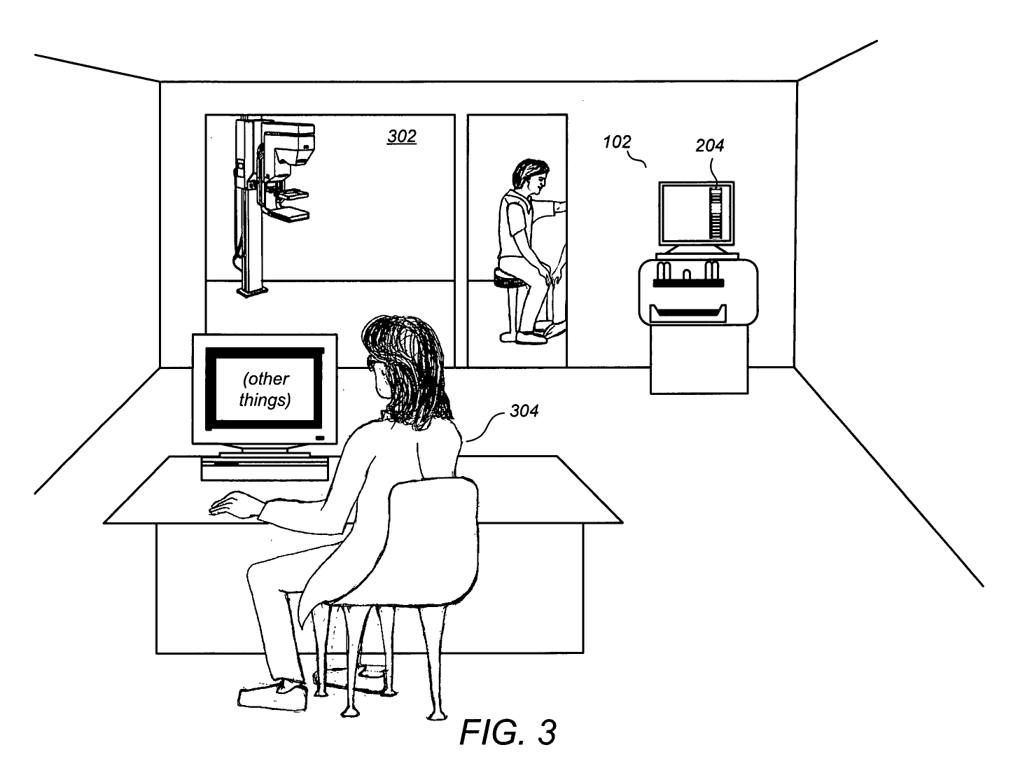

FIG. 3 illustrates a simplified perspective view of the CAD station 102 of FIG. 1 in a typical clinical environment 302. When using a CAD station 102 according to the preferred embodiments, a technologist 304 is advantageously allowed to be going about his or her other activities (e.g. working on other things on an unrelated workstation) at a comfortable and practical distance from the CAD station 102. The technologist 304 can maintain meaningful watch of the process simply by occasional glances at the graphical status indicator 204.

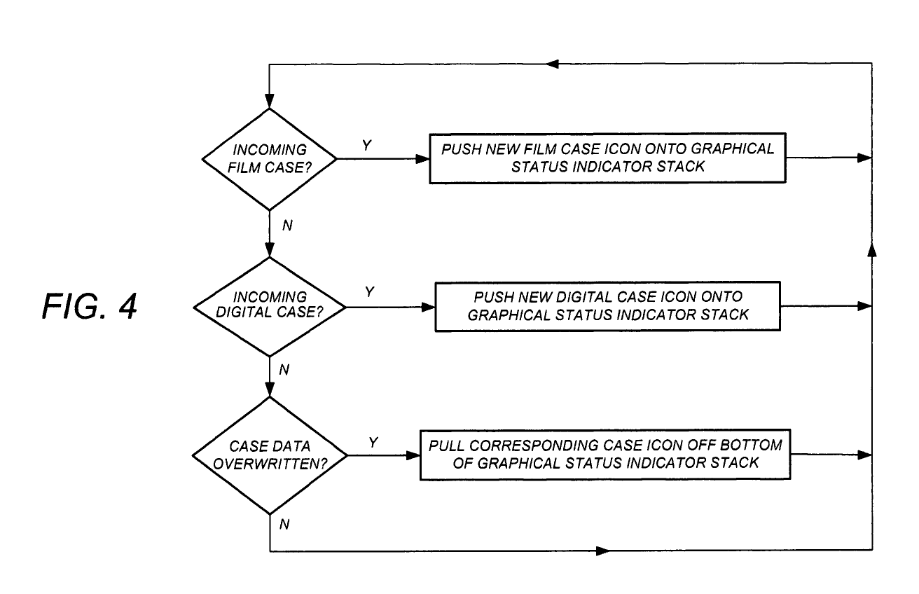

FIG. 4 illustrates steps for pushing case icons onto, and pulling case icons off, a graphical status indicator stack according to a preferred embodiment. If a new film case is being scanned, a corresponding film case icon is pushed onto the stack of case icons 206 in the graphical status indicator 204, i.e., placed at the top spot with the existing case icons being shifted downward. If a new digital has been received, a corresponding digital case icon is pushed onto the stack of case icons. Finally, if a case has been overwritten (because it is the oldest case on the disk and a new case has come in) then the corresponding case icon is pulled off the bottom of the graphical status indicator stack.

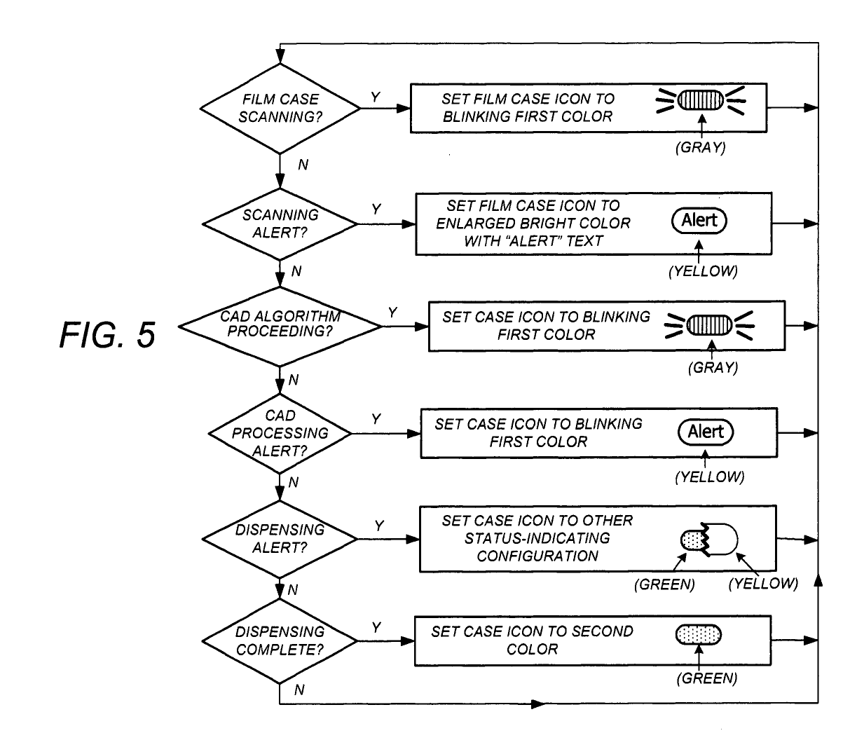

FIG. 5 illustrates steps for updating case icon appearances according to a preferred embodiment. Each case icon is updated as a status of the associated processing changes. It is to be appreciated that while the examples of FIG. 5 represent a particularly useful selection of colors, sizes, visual textures, and shapes, any of a variety of other selections are within the scope of the preferred embodiments, provided that the different processing states are represented by icons that are visually distinguishable from each other at a reasonably substantial distance such as 5 meters. In the particular example of FIG. 5, if a film case is scanning, its corresponding case icon is a blinking gray. If there is a scanning-related alert for that case, then its corresponding case icon is an enlarged, brightly color shape. If a case is being CAD-processed, its corresponding case icon is the blinking gray, although in an optional preferred embodiment it can be a different color, visual texture, size, or shape distinguishable from the film scanning case icon. If there is a CAD-processing-related alert for that case, then its corresponding case icon is an enlarged, brightly color shape, although in an optional preferred embodiment it can be a different color, visual texture, size, or shape distinguishable from the scanning alert case icon.

If the case has been successfully CAD-analyzed and dispensed to its destination device, then its corresponding case icon is a steady green color. If the case has successfully been CAD-analyzed but there has been a dispensing problem (e.g., the destination device is offline, the printer is disconnected, etc.) for that case, then its corresponding case icon can be a half-green, half-yellow-enlarged icon, although in an optional preferred embodiment it can be the same appearance as the scanning alert case icon and the CAD-processing alert case icon. For such dispensing problems, the CAD station 102 will usually keep retrying to dispense the case until a retry limit or timeout is reached. Upon reaching the retry limit or timeout, the case icon is changed to an alert condition similar to the scanning alert case icon or the CAD-processing alert case icon.

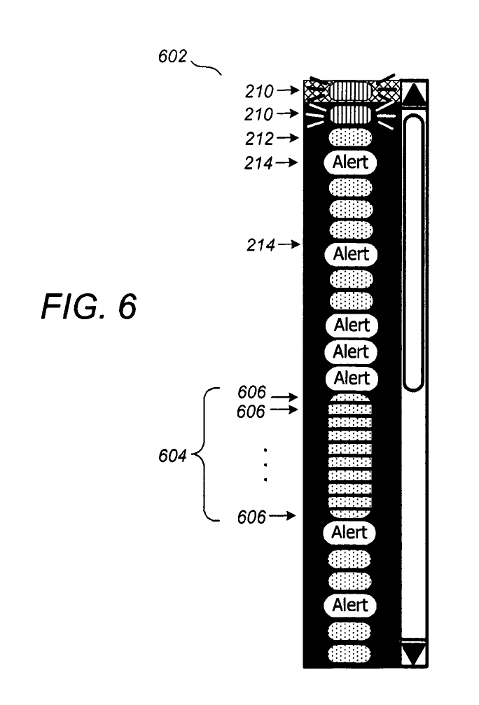

FIG. 6 illustrates a graphical status indicator 602 according to a preferred embodiment. With reference to FIG. 2, supra, the user will often not be as interested in the completed case icons 212 and will be more interested in the alert case icons 214 or the processing case icons 210. Accordingly, the graphical status indicator 602 is generally configured similarly to the graphical status indicator 204, supra, except that when there are several completed case icons 212, those icons are merged together into a merged completed case icon 604 in order to save space on the display for more crucial information. In the preferred embodiment of FIG. 6, the completed case icon 604 is divided up into individual completed case icons 606 separated by lines and still being individually selectable. In other preferred embodiments, the merged completed case icon 604 can simply resemble a single completed case icon.

In one preferred embodiment, the completed case icons 212 are merged together if there are greater than “N” in a row, where “N” is a predetermined number. In another preferred embodiment, the merging of completed case icons can be dependent on the number of alert icons 214 that are in the overall graphical status indicator stack 602, including the non-visible portions that would need scrolling. In particular, the merging would take place so as to increase or maximize the number of alert icons 214 showing on the display at the same time, without scrolling.

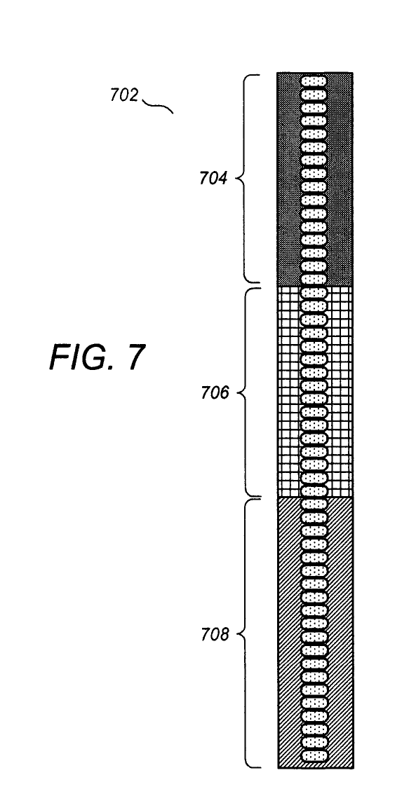

FIG. 7 illustrates a hypothetical extended view of a graphical status indicator 702 according to a preferred embodiment, including the lower portions that would require scrolling to view. For simplicity, it is assumed that the case icons are all identical and represent a completed current state, but in general they will be varied according to the actual statuses of their corresponding cases. As known in the art, film cases are commonly placed onto the scanner in stacks, often corresponding to the scanner capacity (e.g. 20 cases). Upon loading, the technologist then presses the “start” button 238 to begin the process. According to the preferred embodiment of FIG. 7, the graphical status indicator 702 contains different backgrounds in different portions 704, 706, and 708, wherein each of these portions corresponds to a separate stack of film cases. This way, the technologist can quickly determine how their current stack is proceeding versus previous stacks that they loaded earlier in the day as they scroll down the graphical status indicator 702. The preferred embodiment of FIG. 7 is particularly useful when the user has elected to only display film case icons, a capability described supra.

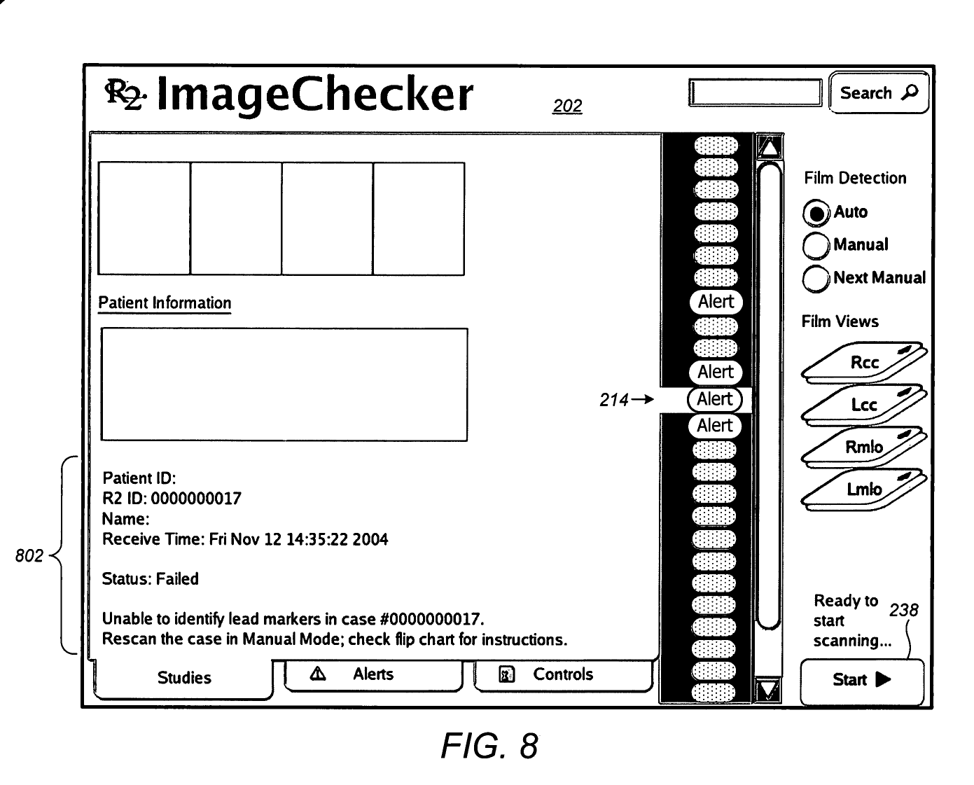

FIG. 8 illustrates the display screen 202 upon user selection of the Alert case icon 214. According to a preferred embodiment, each displayed case icon has softbutton functionality such that it can be selected, preferably by direct touch on a touchscreen but alternatively by mouse click, to immediately bring up the details for that case. Preferably, the display information is graphically connected to the selected case icon, as indicated by the white space extending rightward underneath the Alert case icon 214 in FIG. 8, to indicate logical connection therebetween.

As discussed previously, the Alert case icons 214 can be film case icons or digital case icons depending on the modality of the underlying case. In the particular example of FIG. 8, the Alert case icon 214 is a film case icon that, as indicated by display text 802, corresponds to a film case having a CAD case ID (“R2ID”) of 0000000017 that has failed for inability of the CAD system to identify lead view markers in one or more of the film sheets. The display text 802 includes a suggestion as to how to proceed which, for this error, is to rescan the case in manual mode. Notably, the user can immediately determine that no scanning is now taking place, because the start/stop icon 238 now reads “Start” and nearby text reads, “Ready to start scanning.”

Whereas many alterations and modifications of the present invention will no doubt become apparent to a person of ordinary skill in the art after having read the foregoing description, it is to be understood that the particular embodiments shown and described by way of illustration are in no way intended to be considered limiting. It is to be appreciated, for example, that several of the preferred user interface embodiments described supra are applicable in a digital-only mammographic environment where easy monitoring and control or the digital case receiving, processing, and dispensing is desired. The graphical status indicator can be horizontally oriented, diagonally oriented, etc., without departing from the scope of the preferred embodiments. Further types of temporal changes in icon appearance other than blinking, such as rotating icons, can be used as visual textures or cues without departing from the scope of the preferred embodiments. Even further, although particular reference is made to digital x-ray mammography, the scope of the preferred embodiments includes any of a variety of medical imaging modalities that, either presently or prospectively, are amenable to CAD analysis. Present or prospective examples including computerized tomography (CT) imaging, magnetic resonance imaging (MRI), positron emission tomography (PET), single-photon emission computed tomography (SPECT), and ultrasound, as well as less conventional medical imaging modalities such as thermography, electrical conductivity-based modalities, etc. Therefore, reference to the details of the preferred embodiments are not intended to limit their scope, which is limited only by the scope of the claims set forth below.

What is claimed is:

1. A system for processing mammographic data, comprising:
a digitizer receiving a plurality of film cases arranged in a film case sequence, each film case comprising at least one mammographic film, said digitizer scanning each film case for generating a digitized version thereof;
a processor processing said digitized versions according to at least one computer-aided detection (CAD) algorithm for detecting anatomical abnormalities therein; and
a display coupled with said processor displaying a graphical status indicator comprising a plurality of film case icons, each film case icon corresponding to one of said film cases, wherein said film case icons are spatially ordered according to said film case sequence, and wherein each film case icon is configured to graphically communicate a current state of said scanning and processing for its corresponding film case.

2. The system of claim 1, wherein each film case icon occupies an area of said display sufficient to graphically communicate said current state at a viewing distance of at least five (5) meters.

3. The system of claim 2, wherein each film case icon occupies an area of at least one (1) square centimeter.

4. The system of claim 1, each of said film case icons graphically communicating said current state by varying at least one of a color, size, visual texture, or shape configuration according to said current state.

5. The system of claim 4, wherein each of said film case icons graphically communicates a first current state with a blinking first color and a second current state with an enlarged bright-colored configuration, first current state corresponding to said scanning and processing proceeding, said second current state corresponding to an alert condition.

6. The system of claim 5, said processing comprising:
associating a CAD result set with each of said film cases; and
dispensing said CAD result set to one or more destination devices;
wherein each of said film case icons graphically communicates a third current state with a non-blinking second color, said third current state corresponding to a completion condition in which said CAD result set was successfully dispensed.

7. The system of claim 6, wherein each of said film case icons graphically communicates a fourth current state with a configuration different than that for any of said first, second, or third current states, said fourth current state corresponding to a dispensing error condition.

8. The system of claim 7, wherein “N” or more immediately adjacent spatial occurrences of film case icons corresponding to said third current state are merged on said display, with “N” being a predetermined number.

9. The system of claim 1, further comprising a digital input port for receiving digital cases, each digital case comprising at least one digital mammogram derived from a non-film-based mammography acquisition device, said processor processing each received digital case according to at least one CAD algorithm for detecting anatomical abnormalities therein, wherein said graphical status indicator further comprises a plurality of digital case icons, each digital case icon corresponding to one of said digital cases and being positioned within said spatial order of film case icons on said display according to a time received by said digital input port relative to a plurality of times at which said film cases were scanned, and wherein each digital case icon is configured to graphically communicate a current state of said processing for its corresponding digital case.

10. The system of claim 9, wherein said film case icons and said digital case icons communicate said current states of their corresponding film cases and digital cases, respectively, according to a common status designation scheme.

11. The system of claim 10, wherein said common status designation scheme comprises (i) a blinking first color for a first current state corresponding to said processing proceeding, and (ii) an enlarged bright-colored configuration for a second current state corresponding to an alert condition.

12. A method for processing mammographic data, comprising:
scanning a plurality of film cases to generate digitized versions thereof, each film case comprising at least one mammographic film;
receiving a plurality of digital cases, each digital case comprising at least one digital mammogram derived from a non-film-based mammography acquisition device;
processing said digitized versions and said digital mammograms according to at least one computer-aided detection (CAD) algorithm for detecting anatomical abnormalities therein; and
displaying a graphical status indicator comprising a plurality of film case icons individually corresponding to said film cases and a plurality of digital case icons individually corresponding to said digital cases, wherein said film case icons and digital case icons are in a common spatial arrangement according to a common time sequence in which said film cases were scanned and digital cases received, and wherein each of said film case icons and digital case icons is configured to graphically communicate a current state of said processing for its corresponding film case or digital case, respectively.

13. The method of claim 12, wherein each of said film case icons and digital case icons occupies an area of said display sufficient to graphically communicate said current state at a viewing distance of at least five (5) meters.

14. The method of claim 13, wherein each of said film case icons and digital case icons occupies an area of at least one (1) square centimeter.

15. The method of claim 12, wherein said film case icons and said digital case icons communicate said current states of their corresponding film cases and digital cases, respectively, according to a common status designation scheme.

16. The method of claim 15, wherein said common status designation scheme comprises (i) a blinking first color for a first current state corresponding to said processing proceeding, and (ii) an enlarged bright-colored configuration for a second current state corresponding to an alert condition.

17. The method of claim 16, said processing comprising:
associating a CAD result set with each of said film cases and digital cases; and
dispensing said CAD result set to one or more destination devices;
wherein said common status designation scheme further comprises a third current state with a non-blinking second color, said third current state corresponding to a completion condition in which said CAD result set was successfully dispensed.

18. The method of claim 17, wherein said common status designation scheme further comprises a fourth current state with a configuration different than that for any of said first, second, or third current states, said fourth current state corresponding to a dispensing error condition.

19. The method of claim 18, wherein “N” or more immediately adjacent spatial occurrences of said film and digital case icons corresponding to said third current state are merged on said display, with “N” being a predetermined number.

20. The method of claim 12, wherein said digital case icons communicate said current states of their corresponding digital cases according to a similar status designation scheme used by said film case icons to communicate their current states of their corresponding film cases, with minor alterations to visibly differentiate digital cases from film cases.

21. A method for processing mammographic data, comprising:
receiving a plurality of film cases arranged in a film case sequence, each film case comprising at least one mammographic film;
scanning each of said film cases to generate a digitized version thereof;
processing said digitized versions according to at least one computer-aided detection (CAD) algorithm for detecting anatomical abnormalities therein; and
displaying a graphical status indicator comprising a plurality of film case icons, each film case icon corresponding to one of said film cases, wherein said film case icons are spatially ordered according to said film case sequence, and wherein each film case icon is configured to graphically communicate a current state of said scanning and processing for its corresponding film case.

22. The method of claim 21, wherein each film case icon occupies an area of said display sufficient to graphically communicate said current state at a viewing distance of at least five (5) meters.

23. The method of claim 22, wherein each film case icon occupies an area of at least one (1) square centimeter.

24. The method of claim 21, each of said film case icons graphically communicating said current state by varying at least one of a color, size or shape configuration according to said current state.

25. The method of claim 24, wherein each of said film case icons graphically communicates a first current state with a blinking first color and a second current state with an enlarged bright-colored configuration, first current state corresponding to said scanning and processing proceeding, said second current state corresponding to an alert condition.

26. The method of claim 25, said processing comprising:
associating a CAD result set with each of said film cases; and
dispensing said CAD result set to one or more destination devices;
wherein each of said film case icons graphically communicates a third current state with a non-blinking second color, said third current state corresponding to a completion condition in which said CAD result set was successfully dispensed.

27. The method of claim 26, wherein each of said film case icons graphically communicates a fourth current state with a configuration different than that for any of said first, second, or third current states, said fourth current state corresponding to a dispensing error condition.

28. The method of claim 27, wherein “N” or more immediately adjacent spatial occurrences of film case icons corresponding to said third current state are merged on said display, with “N” being a predetermined number.

29. The method of claim 21, further comprising a digital input port for receiving digital cases, each digital case comprising at least one digital mammogram derived from a non-film-based mammography acquisition device, said processor processing each received digital case according to at least one CAD algorithm for detecting anatomical abnormalities therein, wherein said graphical status indicator further comprises a plurality of digital case icons, each digital case icon corresponding to one of said digital cases and being positioned within said spatial order of film case icons on said display according to a time received by said digital input port relative to a plurality of times at which said film cases were scanned, and wherein each digital case icon is configured to graphically communicate a current state of said processing for its corresponding digital case.

30. The method of claim 29, wherein said film case icons and said digital case icons communicate said current states of their corresponding film cases and digital cases, respectively, according to a common status designation scheme.

31. The method of claim 30, wherein said common status designation scheme comprises (i) a blinking first color for a first current state corresponding to said processing proceeding, and (ii) an enlarged bright-colored configuration for a second current state corresponding to an alert condition.

32. A method for processing mammographic data, comprising:
receiving a plurality of cases, each case comprising at least one of a digital and digitized mammogram;
processing said cases according to at least one computer-aided detection (CAD) algorithm for detecting anatomical abnormalities therein; and
displaying a graphical status indicator comprising a plurality of case icons, each case icon corresponding to either (i) one of said cases, or (ii) a group of said cases received adjacently in time and having a common current processing state associated with said processing, wherein each case icon is configured to graphically communicate the current state associated with said processing for its corresponding case or group of cases, wherein each case icon graphically communicates said current state by varying at least one of a color, size, visual texture, or shape configuration according to said current state, and wherein said case icons are spatially arranged according to the time received.

33. The method of claim 32, wherein each of said case icons graphically communicates a first current state with a first visual texture and a second current state with an enlarged bright-colored second visual texture, first current state corresponding to said processing proceeding, said second current state corresponding to an alert condition.

34. The method of claim 33, said processing comprising:
associating a CAD result set with each of said cases; and
dispensing said CAD result set to one or more destination devices;
wherein each of said case icons graphically communicates a third current state with a third visual texture, said third current state corresponding to a completion condition in which said CAD result set was successfully dispensed.
